(19) United States
(12) Patent Application Publication
(10) Pub. No.: US 2007/0229920 A1
(43) Pub. Date: Oct. 4, 2007

(54) Image processing apparatus, system, information processing apparatus, and program

(75) Inventor: Naoto Fukushima, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/656,310

(22) Filed: Jan. 19, 2007

(30) Foreign Application Priority Data
Mar. 28, 2006 (JP) 2006-088799

(51) Int. Cl. H04N 1/387

(52) U.S. Cl. 358/488; 358/452

(57) ABSTRACT

The image processing apparatus comprises a document reading portion that optically reads an original document and inputs image data, a digital signature adding control portion that adds a digital signature to the read image data, a reading condition value setting portion that sets reading condition values by the kind of original document at the time of reading the original document by the document reading portion, and a reading condition matching determining portion that determines whether the set reading condition values match predetermined reading condition standard values. The digital signature adding control portion does not add the digital signature to the image data read at the document reading portion when, as a result of the determination by the reading condition matching determining portion, the reading condition values do not match the predetermined reading condition standard values.

### CROSS-NOTING PARAGRAPH

This Nonprovisional application claims priority under 35 U.S.C. §119(a) on Patent Application No. 2006-088799 filed in JAPAN on Mar. 28, 2006, the entire contents of which are hereby incorporated herein by references.

### FIELD OF THE INVENTION

The present invention relates generally to an image processing apparatus, a system, an information processing apparatus, and a program, and more particularly, to an image processing apparatus, a system, an information processing apparatus, and a program that have a function of adding a digital signature, etc., to image data input by reading out an original document.

### BACKGROUND OF THE INVENTION

The so-called e-Document Law (referring to two Laws, “Law Governing the Use of Information and Communications Technology in the Preservation of Documents that Private Business Perform” and “Law concerning Adjustment, Etc., of Relevant Laws in Accordance with Enforcement of the Law”) granting the originality to data obtained by digitizing a paper document in Japan came into force in April, 2005. As a result, a digital multi-functional peripheral (hereinafter, multi-functional peripheral) having a scanner/fax function capable of reading a paper document, within which the paper document can be converted to digital data, attracts attention as representing the technology related with the e-Document Law.

The e-Document Law suggests that guidelines be prepared for each Ministry in digitizing data and the guidelines by some Ministries have incorporated conditions of document digitizing including adding, etc., of a digital signature, time stamp, etc. For example, National Tax Administration Agency calls for enterprises to apply for machines to be used, specifying a name of the machine, scanning resolution, color gradation, etc., before granting permission to application of the e-Document Law. At present, there is an increasing expectation for the multi-functional peripheral equipped with functions for executing the digitizing processing in accordance with such series of conditions.

Conventionally known as the multi-functional peripherals equipped with the digital signature function are, for example, the peripherals described in Japanese Laid-Open Patent Publication Nos. 2004-151896, 2004-151897, and 2002-368915. The multi-functional peripherals described in Japanese Laid-Open Patent Publication Nos. 2004-151896 and 2004-151897 relate to the technology of determining whether a user of the multi-functional peripheral and a digital signer match each other, using an IC card, etc. The multi-functional peripheral described in Japanese Laid-Open Patent Publication No. 2002-368915, for example, has a mode of being capable of setting whether to print out image data with the digital signature added thereto, and relates to post-digital-signature technology.

However, in conventional multi-functional peripherals including those described in Japanese Laid-Open Patent Publication Nos. 2004-151896, 2004-151897, and 2002-368915, in reading the paper document, setting for the reading can be arbitrarily changed by a user. Accordingly, there arises a possibility that even if the setting made for the reading is the setting not conforming to the guidelines of the e-Document Law, the image data is added with the digital signature and is treated as an original, without conforming to the reading conditions of the guidelines.

Namely, in conventional multi-functional peripherals equipped with the digital signature function, it is left to the judgment of the user whether reading condition values set at the multi-functional peripheral itself match reading condition standard values complying with the guidelines of the e-Document Law and it is possible that the user can make an error in the operation of setting reading condition values. Adding the digital signature using the multi-functional peripheral for which an approval has not been applied or obtained constitutes discrepancy from contents of application and is not desirable. If the digitized data is so important, consideration against such human error becomes all the more necessary.

### SUMMARY OF THE INVENTION

It is the object of the present invention to provide an image processing apparatus, a system, an information processing apparatus, and a program, capable of executing a processing of comparing predetermined reading condition standard values complying with guidelines, etc., of the e-Document Law and reading condition values set at an apparatus itself and, only when thus set reading condition values match the predetermined reading condition standard values, adding a digital signature, time stamp, etc., to image data read from an original document, thereby reducing human errors such as an error in an operation of setting reading condition values by a user.

Another object of the present invention is to provide an image processing apparatus comprising: a reading portion that optically reads an original document and inputs image data; and a digital signature adding portion that adds a digital signature to the read image data, wherein the image processing apparatus comprises: a reading condition value setting portion that sets, at the time of reading of original document by the reading portion, reading condition values by a kind or an address for submission of the original document; and a reading condition matching determining portion that determines whether the set reading condition values match predetermined reading condition standard values, wherein the digital signature adding portion does not add a digital signature to the image data read at the reading portion when, as a result of determination by the reading condition matching determining portion, the reading condition values do not match the predetermined reading condition standard values.

Another object of the present invention is to provide the image processing apparatus, comprising: a storage portion that stores predetermined reading condition standard values by a kind or an address for submission of original document; and a control portion that controls processing of rewriting the predetermined reading condition standard values, wherein the predetermined reading condition standard values can be rewritten before reading of original document by the reading portion.

Another object of the present invention is to provide the image processing apparatus, comprising: a connecting portion that connects with an external storage device that stores predetermined reading condition standard values by a kind or an address for submission of original document, wherein the predetermined reading condition standard values stored in the external storage device can be read before reading of original document by the reading portion.

Another object of the present invention is to provide the image processing apparatus, wherein the reading condition value setting portion can not set a value less than a minimum value out of the predetermined reading condition standard values at the time of setting reading condition values by a kind or an address for submission of original document.

Another object of the present invention is to provide the image processing apparatus, wherein the reading condition value setting portion can set, at the time of reading of original document by the reading portion, reading condition values by a kind or an address for submission of the original document in accordance with input by a user.

Another object of the present invention is to provide the image processing apparatus, wherein the reading condition value setting portion can determine a kind or an address for submission of original document and can set, at the time of reading of original document by the reading portion, reading condition values by a kind or an address for submission of the original document, in accordance with the determined kind or address for submission of the original document.

Another object of the present invention is to provide the image processing apparatus, comprising a reading condition table in which prohibited setting items can be specified by a kind or an address for submission of original document, wherein the reading condition value setting portion, at the time of setting reading condition values by a kind or an address for submission of original document, refers to the reading condition table and, when prohibited setting items are specified for the kind or the address for submission of the original document, can not set the specified prohibited setting items.

Another object of the present invention is to provide the image processing apparatus, comprising: a reading condition table in which visual confirming condition can be specified by a kind or an address for submission of original document; and a display portion that displays various kinds of information, wherein the reading condition value setting portion, at the time of setting reading condition values by a kind or an address for submission of original document, refers to the reading condition table and, when the visual confirming condition is specified for the kind or the address for submission of the original document, displays, at the display portion, the image data read by the reading portion, before adding a digital signature.

Another object of the present invention is to provide the image processing apparatus, wherein the digital signature adding portion, when the visual confirming by the display portion has been executed, adds a digital signature to the image data read at the reading portion, based on information indicating that the visual confirming has been executed.

Another object of the present invention is to provide the image processing apparatus connectable with an external display apparatus having a screen of a size equal to or larger than a predetermined size, wherein when the screen size of the display portion is smaller than the predetermined size, the image data read at the reading portion is output for display at the external display apparatus.

Another object of the present invention is to provide the image processing apparatus, comprising an OCR portion that converts the image data read at the reading portion to character data and calculates a point number of the character data, wherein when the point number of the character data calculated by the OCR portion is smaller than predetermined point number, the digital signature adding portion does not add a digital signature to the image data read at the reading portion.

Another object of the present invention is to provide the image processing apparatus, wherein when the point number of the character data calculated by the OCR portion is smaller than predetermined point number, the display portion displays information giving notice to that effect.

Another object of the present invention is to provide the image processing apparatus, comprising: a storage portion that stores a maximum value of each reading performance item of the reading portion; and a reading performance determining portion that determines whether the maximum value of each reading performance item matches the predetermined reading condition standard values at the time of reading of original document by the reading portion, wherein when, as a result of the determination by the reading performance determining portion, the maximum value of each reading performance item does not match any of the predetermined reading condition standard values, the digital signature adding portion does not execute digital signature processing to the original document.

Another object of the present invention is to provide the image processing apparatus, wherein when, as a result of determination by the reading performance determining portion, the maximum value of each reading performance item does not match any of the predetermined reading condition standard values, the digital signature adding portion suspends reading processing before the original document is read by the reading portion.

Another object of the present invention is to provide the image processing apparatus, comprising: a time stamp adding portion that adds a time stamp to image data; and a reading condition table in which a time stamp condition can be specified by a kind or an address for submission of original document, wherein when a time stamp condition is specified in the reading condition table and a digital signature is not added to the image data read at the reading portion, the time stamp adding portion does not add a time stamp to the image data.

Another object of the present invention is to provide the image processing apparatus, comprising a storage portion that stores information indicating that the digital signature has been added to the image data read at the reading portion, wherein when the information indicating that the digital signature has been added is stored, the time stamp adding portion further adds a time stamp to the image data with the digital signature added thereto.

Another object of the present invention is to provide an image processing system comprising: an image processing apparatus that optically reads an original document and inputs image data; and an information processing apparatus connected to the image processing apparatus, wherein the information processing apparatus comprises: a digital signature adding portion that adds a digital signature to image data; a reading condition value setting portion that sets reading condition values by a kind or an address for submission of original document at the time of reading of original document by the reading portion; and a reading condition matching determining portion that determines whether the set reading condition values match predetermined reading condition standard values, wherein the digital signature adding portion does not add a digital signature to the image data read at the reading portion when, as a result of determination by the reading condition matching determining portion, the reading condition values do not match the predetermined reading condition standard values.

Another object of the present invention is to provide the image processing system, wherein the image processing apparatus comprises: a storage portion that stores a maximum value of each reading performance item of the image processing apparatus; and a reading performance determining portion that determines whether the maximum value of each reading performance item matches the predetermined reading condition standard values at the time of reading of original document by the image processing apparatus, wherein when, as a result of determination by the reading performance determining portion, the maximum value of each reading performance item does not match any of the predetermined reading condition standard values, the information processing apparatus does not execute digital signature processing to the original document.

Another object of the present invention is to provide the image processing system, wherein the image processing apparatus comprises: a time stamp adding portion that adds a time stamp to image data; and a reading condition table in which a time stamp condition can be specified by a kind or an address for submission of original document, wherein when a time stamp condition is specified in the reading condition table and a digital signature is not added to the image data read at the image processing apparatus, the time stamp adding portion does not add a time stamp to the image data.

Another object of the present invention is to provide an information processing apparatus connectable to an image processing apparatus that optically reads an original document and inputs image data, comprising: a digital signature adding portion that adds a digital signature to image data; a reading condition value setting portion that sets reading condition values by a kind or an address for submission of original document at the time of reading of original document by the image processing apparatus; and a reading condition matching determining portion that determines whether the set reading condition values match predetermined reading condition standard values, wherein the digital signature adding portion does not add a digital signature to the image data read at the image processing apparatus when, as a result of determination by the reading condition matching determining portion, the reading condition values do not match the predetermined reading condition standard values.

Another object of the present invention is to provide the information processing apparatus, comprising: a storage portion that stores a maximum value of each reading performance item of the image processing apparatus; and a reading performance determining portion that determines whether the maximum value of each reading performance item matches the predetermined reading condition standard values at the time of reading of original document by the image processing apparatus, wherein when, as a result of determination by the reading performance determining portion, the maximum value of each reading performance item does not match any of the predetermined reading condition standard values, the digital signature adding portion does not execute digital signature processing to the original document.

Another object of the present invention is to provide the information processing apparatus, comprising: a time stamp adding portion that adds a time stamp to image data; and a reading condition table in which a time stamp condition can be specified by a kind or an address for submission of original document, wherein when the time stamp condition is specified in the reading condition table and a digital signature is not added to the image data read at the image processing apparatus, the time stamp adding portion does not add a time stamp to the image data.

Another object of the present invention is to provide an image processing method of an image processing apparatus having a reading portion that optically reads an original document and inputs image data, comprising: a step of setting reading condition values by a kind or an address for submission of original document at the time of reading of original document by the reading portion; a step of determining whether the set reading condition values match predetermined reading condition standard values; and a step of controlling addition of a digital signature to the image data read at the reading portion based on a result of determination.

Another object of the present invention is to provide the image processing method, comprising: a step of determining whether a maximum value of each reading performance item of the reading portion matches the predetermined reading condition standard values at the time of reading of original document by the image processing apparatus; and a step of controlling addition of a digital signature to the image data read at the reading portion based on a result of determination.

Another object of the present invention is to provide the image processing method, comprising: a step of controlling addition of a time stamp to the image data read at the reading portion based on a reading condition table in which a time stamp condition can be specified by a kind or an address for submission of original document; and not adding a time stamp to the image data when a time stamp condition is specified in the reading condition table and a digital signature is not added to the image data read at the reading portion.

Another object of the present invention is to provide a program for executing a function as the image processing apparatus.

Another object of the present invention is to provide a program for executing a function as the information processing apparatus.

### BRIEF DESCRIPTION OF THE DRAWINGS

FIG. 1 depicts an example of configuration in a network of an image processing apparatus according to an embodiment of the present invention;

FIG. 2 is a block diagram of an example of configuration of a multi-functional peripheral of the present invention;

FIG. 3 is a flow chart for description of a flow of overall image processing according to the multi-functional peripheral of the present invention;

FIG. 4 depicts an example of a reading condition table;

FIG. 5 depicts an example of a reading performance value table registered with a maximum value of each reading performance item of a document reading portion;

FIG. 6 depicts an example of an operation screen at the time of selecting and fixing inputting the kind of document to be digitized;

FIG. 7 depicts an example of an operation screen at the time of inputting to set reading condition values;

FIG. 8 depicts an example of a screen with prohibited setting items grayed out;

FIG. 9 depicts an example of a screen displaying image data read at the document reading portion;

FIG. 10 depicts an example of an image visual confirming table;

FIG. 11 depicts kinds of parameters, and meanings thereof, to be registered for visual confirming and digital signature that are processing items within the image visual confirming table shown in FIG. 10;

FIG. 12 is a flow chart for description of a flow of overall processing of scanning with the digital signature/time stamp;

FIG. 13 is a flow chart for detailed description of scanner performance judging processing at step S11 of FIG. 12;

FIG. 14 is a flow chart for detailed description of the reading condition match judging processing at step S15 of FIG. 12;

FIG. 15 is a flow chart for detailed description of read image visual confirming processing at step S18 of FIG. 12;

FIG. 16 is a flow chart for detailed description of digital signature processing at step S20 of FIG. 12;

FIG. 17 is a flow chart for detailed description of time stamp processing at step S22 of FIG. 12;

FIG. 18 depicts a configuration example of an image processing system according to another embodiment of the present invention; and

FIG. 19 depicts a configuration example of the information processing apparatus according to other embodiment of the present invention.

### PREFERRED EMBODIMENTS OF THE INVENTION

Description will then be made of preferred embodiments of an image processing apparatus, a system, an information processing apparatus, and a program according to the present invention, with reference to accompanying drawings. If any part in a drawing has same function as that of other part in other drawing, same reference numeral is given thereto, with repeated description omitted.

### First Embodiment

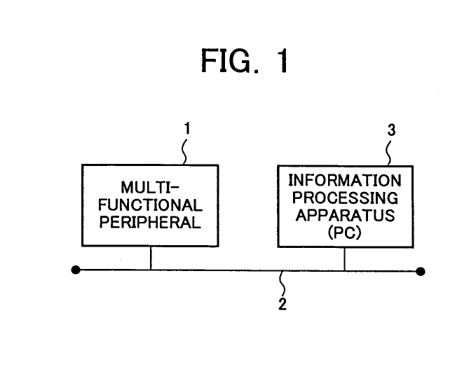

FIG. 1 depicts an example of configuration in a network of an image processing apparatus according to an embodiment of the present invention. In this Figure, 1 indicates the image processing apparatus, 2 the network, and 3 an information processing apparatus such as a personal computer (PC). The image processing apparatus 1 can connect with the information processing apparatus 3 by way of the network 2 and is capable of mutual communication with the information processing apparatus 3 by receiving data therefrom and sending the data thereto.

The image processing apparatus 1 of the present embodiment is equipped with a copying function, a print function, a network printer function, a facsimile function, a scanner function, etc., in the same way as an ordinary digital multi-functional peripheral (hereinafter, multi-functional peripheral) is and executes image processing by these functions, but is not necessarily required to have all of these functions. While description will be made using the multi-functional peripheral equipped with a digital signature function and/or a time stamp function as a representative example of the image processing apparatus 1, the present invention is applicable not limitedly to such a multi-functional peripheral, but to all image processing apparatuses equipped with the scanner function, a digital signature adding function, a communication function, a memory function, a display function, etc.

As described above, the e-Document Law, etc., specify reading condition standard values for adding a digital signature or time stamp to a document digitized by scanning. The reading condition standard values include a scanning resolution, a color/monochrome image, a color gradation, etc. The image processing apparatus 1 according to the present invention (hereinafter, multi-functional peripheral 1) executes a control so that a digitized document is generated at or above the reading condition standard values complying with the guidelines, etc., of the e-Document Law by determining whether the reading condition values set for the multi-functional peripheral 1 match the reading condition standard values at the time of scanning an original document for adding the digital signature or time stamp and by adding the digital signature, etc., only in the case of matching.

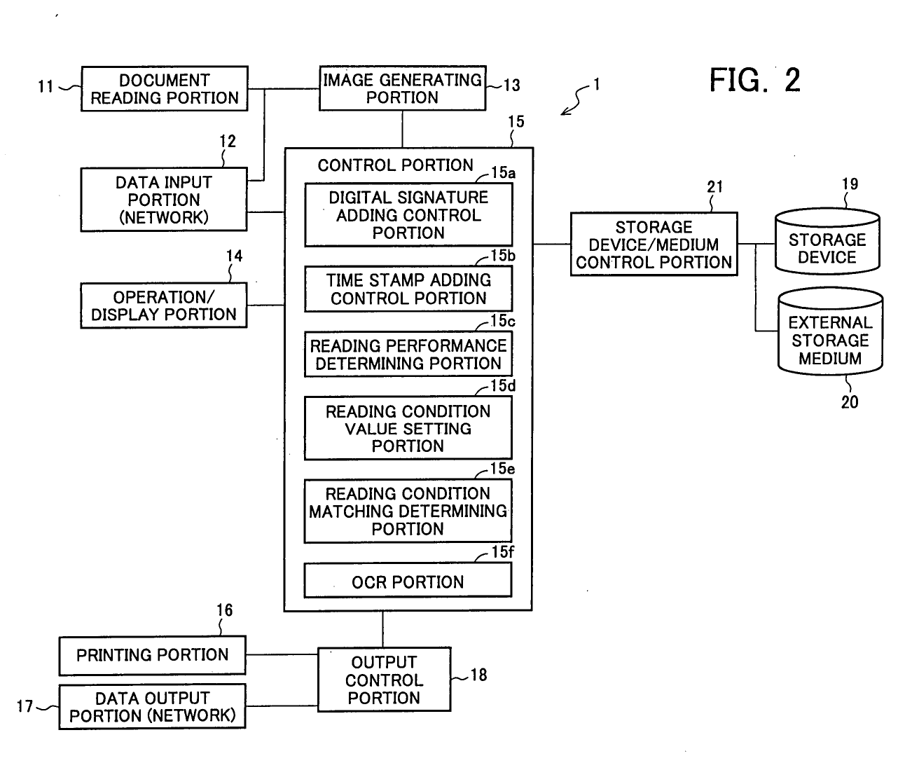

FIG. 2 is a block diagram of an example of configuration of the multi-functional peripheral 1 of the present invention. In the Figure, the multi-functional peripheral 1 comprises a document reading portion 11 that optically reads the original document, a data input portion 12 that inputs the data by way of the network 2, an image generating portion 13 that converts a signal from the document reading portion 11 or the data input portion 12 into image data, an operation/display portion 14 that displays various kinds of information and/or gives operational instructions to the multi-functional peripheral 1, a control portion 15 that controls the operation of the multi-functional peripheral 1, a printing portion 16 that prints out the image data, a data output portion 17 that outputs the data by way of the network 2, an output control portion 18 that controls the operation of the printing portion 16 and the data output portion 17, a storage device 19 such as a hard disk, a semiconductor memory, etc., an external storage medium 20 such as a USB memory, a memory card, etc., and a storage device/medium control portion 21 that controls the operation of the storage device 19 and the external storage medium 20.

The multi-functional peripheral 1 is equipped with the control portion 15 comprising a CPU that executes arithmetic operations and a RAM, etc. that store temporary information. The control portion 15 includes a ROM that has stored a control program for controlling the multi-functional peripheral 1. This ROM stores portions for executing the functions of the image processing apparatus of the present invention, namely, a digital signature adding control portion 15a, a time stamp adding control portion 15b, a reading performance determining portion 15c, a reading condition value setting portion 15d, a reading condition matching determining portion 15e, and an OCR (Optical Character Reader) portion 15f, all in the form of programs, which are read out by the CPU to the RAM for processing at the time of execution. The multi-functional peripheral 1 may be configured not to include the OCR portion 15f when an OCR processing of converting the image data to character data is not executed.

In FIG. 2, the signal input by scanning at the document reading portion 11 is converted by the image generating portion 13 to the image data, and depending on processing conditions of the control portion 15, processing moves to the storage device/medium control portion 21 and the image data is stored in the storage device 19 or the external storage medium 20. The document reading portion 11 and the image generating portion 13 correspond to a reading portion of the present invention. The control portion 15 is equipped with the digital signature adding control portion 15a and the time stamp adding control portion 15b and executes the processing of adding the digital signature or time stamp to the image data after scanning.

The operation/display portion 14, comprising a display screen such as a liquid crystal display (LCD) that displays various kinds of information and a touch panel provided on the display screen, enables the user to select among various functions to be used and give the operational instructions to the multi-functional peripheral 1. For example, when the scanning function is selected, a screen is displayed for the user to further select whether to add the digital signature/time stamp. The operation/display portion 14 enables the visual confirming of the scanned image data.

The data input portion 12 and the data output portion 17 make up a communication portion for connecting and communicating with external devices such as the information processing apparatus 3 by way of the network 2 and enable the input and output of various kinds of data such as the image data. The data input portion 12 corresponds to a connecting portion of the present invention and not only receives print data, fax data, etc., but also connects with the external storage device to enable a reading condition table at the time of adding the digital signature or the time stamp to be obtained.

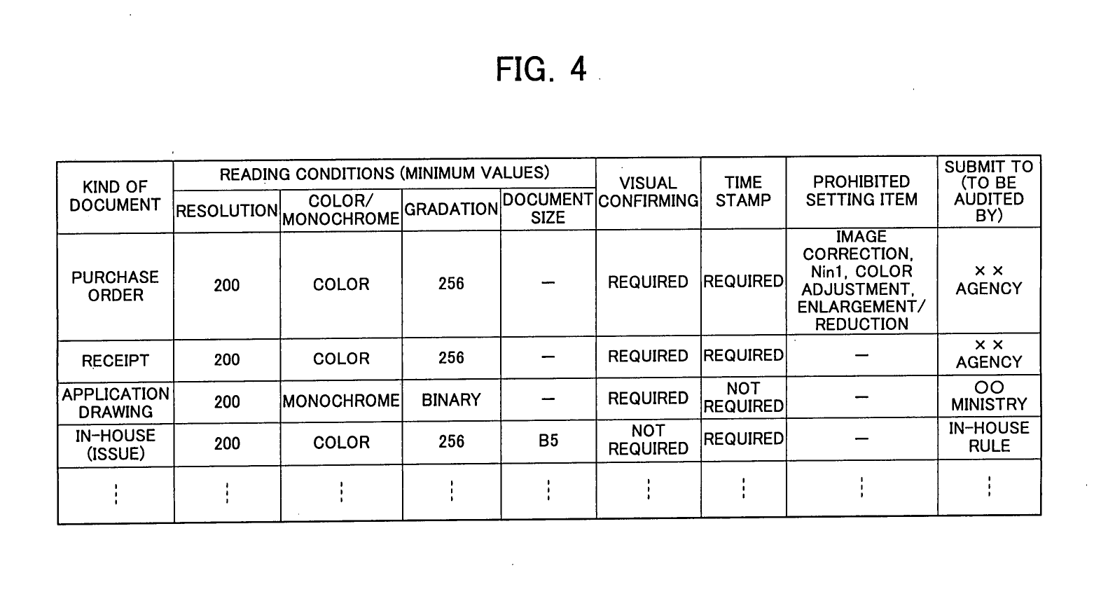

The storage device 19 or the external storage medium 20 stores the reading condition table (see FIG. 4 to be described later) registered with predetermined reading condition standard values by the kind or address for submission of original document. For example, e-Document Law suggests guidelines of reading conditions by each Ministry in digitizing the data. Accordingly, depending on the kind of original document (purchase order, receipts, etc.) or address for submission of the original document (ministries, etc.), predetermined reading condition standard values (minimum values) complying with the guidelines of the e-Document Law are registered as a table data, etc., in advance. While the following description will be made, citing examples of the predetermined reading condition standard values according to the kind of original document, the predetermined reading condition standard values may be registered according to the address for submission of the original document.

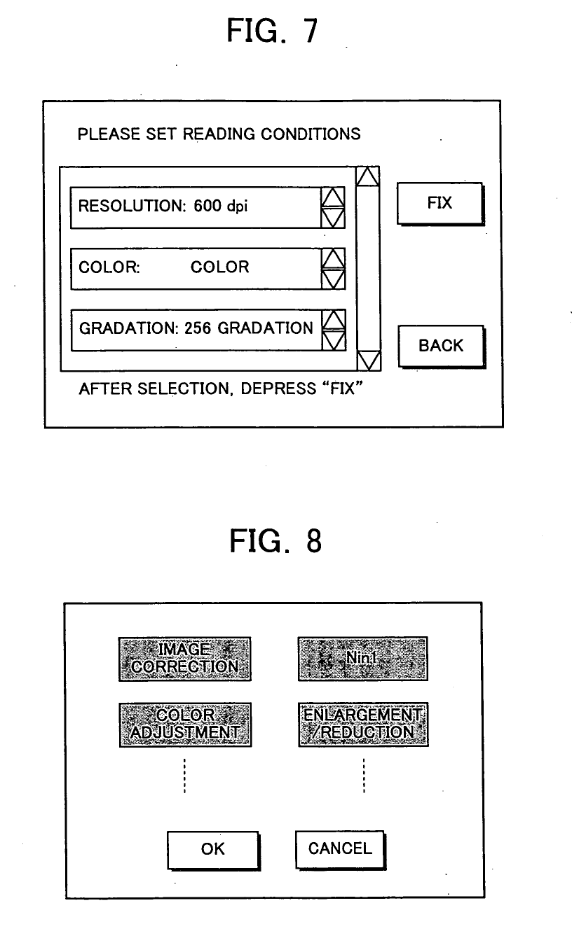

The reading condition value setting portion 15d sets the reading condition values by the kind of original document at the time of reading the original document by the document reading portion 11, and for example, it may be so arranged that such setting can be made according to the input by the user, as shown in FIG. 7 to be described later. The reading condition matching determining portion 15e determines whether the reading condition values set at the reading condition value setting portion 15d match the predetermined reading condition standard values. In this connection, for example, if the reading condition values input by the user when the document is read are greater than or equal to the predetermined reading condition standard values (minimum values) registered in the reading condition table, these values are determined to match each other. The predetermined reading condition standard values include the resolution of the scanner, the color, the gradation, the document size, etc.

The digital signature adding control portion 15a adds the digital signature to the image data read at the document reading portion 11 only when, as a result of the determination by the reading condition matching determining portion 15e, the reading condition values match the predetermined reading condition standard values, and does not add the digital signature to the image data when these two sets of values do not match each other. As a result, digitizing is made at the predetermined reading condition standard values complying with the guidelines, etc., of the e-Document Law since it is so designed that the digital signature is not added even if the user erroneously sets values less than the predetermined reading condition standard values. This, therefore, can reduce the human errors such as erroneous operation of setting reading condition values by the user.

When a plurality of multi-functional peripherals 1 are connected to the network and the reading condition table is stored in the fixed storage device 19 such as the ROM of each multi-functional peripheral 1, for example, any change made to the scanner reading conditions based on laws, regulations and rules such as the e-Document Law makes it necessary to change the values of the reading condition table of each multi-functional peripheral 1 according to such change of the reading conditions, thereby imposing a heavy burden on user's work.

Accordingly, a latest reading condition table may be stored in one external storage device such as the information processing apparatus 3 that can connect with the plurality of multi-functional peripherals 1 by way of the network 2. When a change, etc., is made to the reading conditions in the laws, regulations and rules such as the e-Document Law, only the reading condition table stored in the external storage device is changed and is constantly kept in the latest status. Each multi-functional peripheral 1, before reading the original document, reads out the latest reading condition table from the external storage device and rewrites the reading conditions already registered in the reading condition table stored in the storage device 19.

Specifically, the control portion 15 controls processing of rewriting the predetermined reading condition standard values in the reading condition table stored in the storage device 19 or the external storage medium 20. The data input portion 12 constitutes the connecting portion that connects with the information processing apparatus 3, which is the external storage device storing the latest reading condition table, by way of the network 2. In the case of registering changes of the reading conditions in accordance with revisions of laws or newly registering the reading conditions, changes are made only to the reading condition table stored in the information processing apparatus 3 and the table is constantly kept in the latest status.

The data input portion 12, before the reading of the original document by the document reading portion 11, reads the latest reading condition table stored in the information processing apparatus 3 in accordance with an instruction from the control portion 15 and the control portion 15 executes the processing of rewriting the reading conditions already registered in the reading condition table stored in the storage device 19 or external storage medium 20.

While in the above example, description has been made about the configuration of reading out the latest reading condition table from the information processing apparatus, it may be so arranged that the latest reading condition table is stored in the external storage device such as the USB memory or the memory card and the reading condition table is read out therefrom.

As seen above, by the configuration of reading out the reading condition table into the memory or the storage device of the multi-functional peripheral, when the change, etc., is made to the scanner reading conditions based on the laws, regulations and rules such as the e-Document Law, the change on the multi-functional peripheral as well is made only by changing the reading condition table of the apparatus such as the PC into which the table is originally read, without necessity of taking any action in connection with the change on the multi-functional peripheral itself. Furthermore, since only by changing the reading condition table in one PC on the network, the plurality of multi-functional peripherals, by utilizing this, can execute the change processing, the more the number of multi-functional peripherals becomes, the less the workload required for taking action in connection with the change becomes.

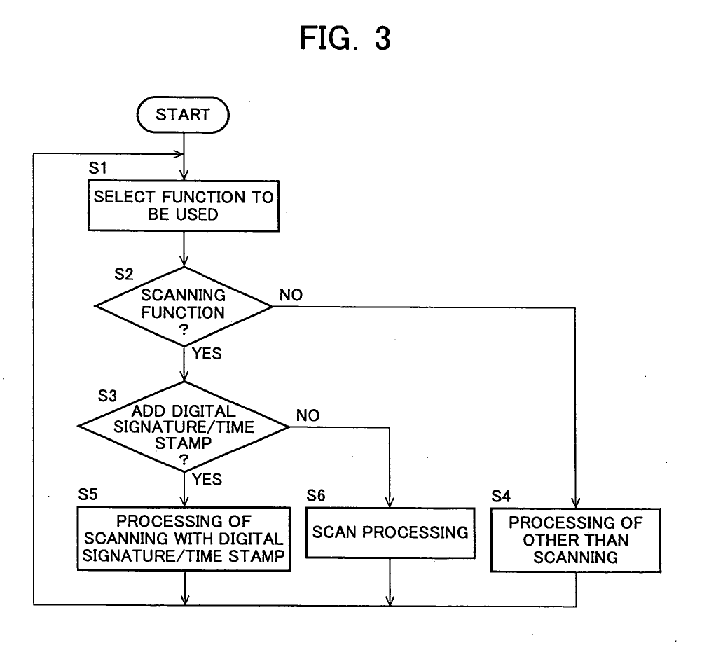

FIG. 3 is a flow chart for description of a flow of overall image processing according to the multi-functional peripheral 1 of the present invention. The multi-functional peripheral 1, after starting, causes the operation/display portion 14 to display a function selection screen, and through this operation/display portion 14, the user selects the function to be used (step S1). Judgement is made of whether the selected function is a scanning function (step S2) and if the scanning function is selected (step S2: Yes), then judgment is made of whether the user has selected a digital signature/time stamp adding function (step S3). At step S2, if the scanning function is not selected (step S2: No), then the processing other than the scanning is executed (step S4).

Next, if the digital signature/time stamp adding function is selected at step S3 (step S3: Yes), then the multi-functional peripheral 1 executes processing of scanning with the digital signature/time stamp (step S5). If the digital signature/time stamp adding function is not selected at step S3 (step S3: No), then ordinary scanning processing is executed (step S6).

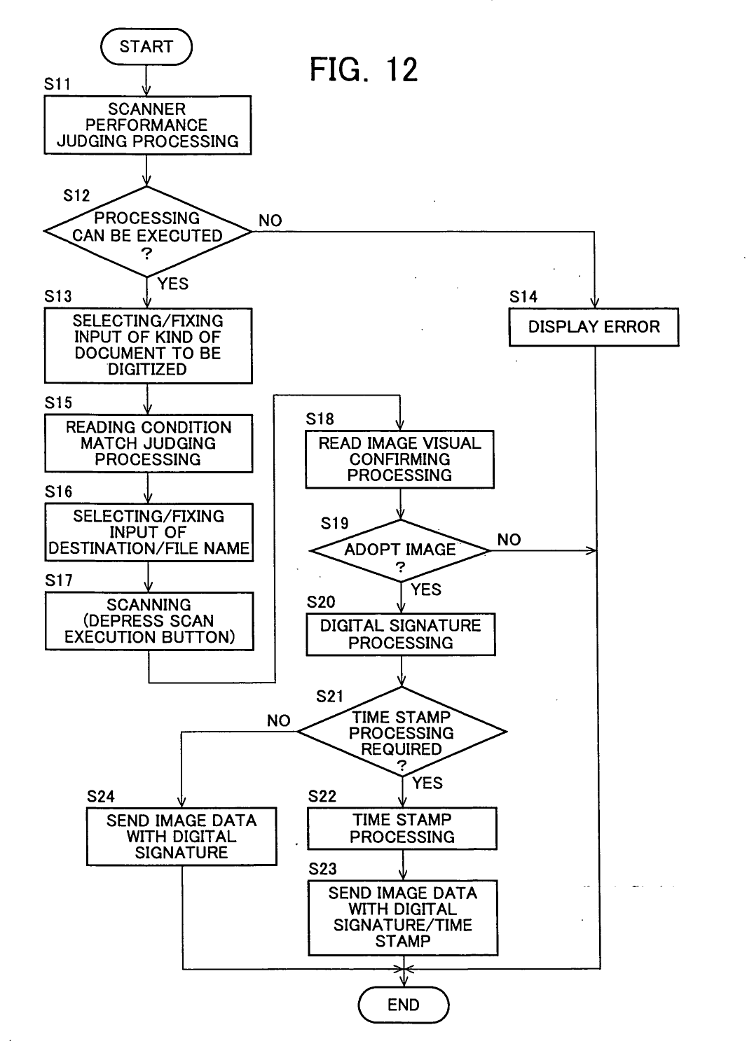

In FIG. 3, the user who intends to add the digital signature or the time stamp to the scanned image data selects the scanning function and further selects the digital signature/time stamp adding function. By this, the selection of the processing of scanning with the digital signature/time stamp is fixed. The flow for such processing is shown in FIG. 12 and subsequent Figures to be described later.

FIG. 4 depicts an example of the reading condition table. This reading condition table has been registered with the scanning reading conditions, etc., in accordance with the laws, regulations and rules such as the e-Document Law and is prepared by an administrator, etc., in advance and is stored in the storage device 19 or the external storage medium 20 or the information processing apparatus 3. These reading conditions are classified by the kind of original document (or address for submission) and are so arranged that a value can be set at each item including the reading conditions depending on the kind of document.

The reading condition table includes, for example, the minimum value of each of resolution, color, gradation, and document size as the reading conditions, visual confirming condition, time stamp condition, prohibited setting item, etc., for each kind of original document (or address for submission). In FIG. 4, in the example of “purchase order”, the registration is made as follows; resolution: 200 dpi; color/monochrome: color; gradation: 256, visual confirming: required, time stamp: required, prohibited setting item: image correction; Nin1 (collective printing); color adjustment; enlargement/reduction, etc.

As described above, the reading condition matching determining portion 15e determines, based on the above reading condition table, whether the reading condition values set at the reading condition value setting portion 15d match the predetermined reading condition standard values. For example, if the reading condition values input by the user is greater than or equal to the predetermined reading condition standard values (minimum values), then these values are determined to match each other.

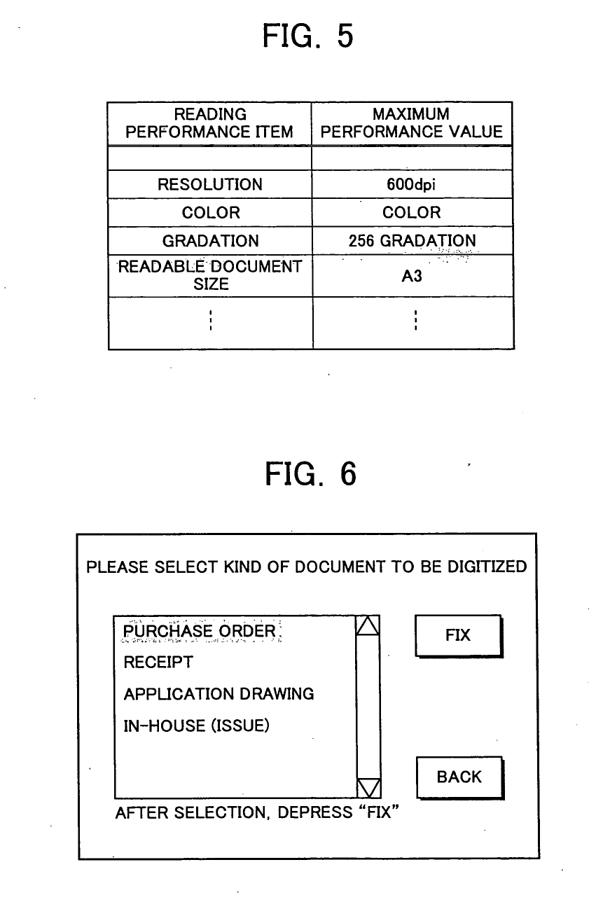

FIG. 5 depicts an example of a reading performance value table registered with a maximum value of each reading performance item of the document reading portion 11. In the case of executing the processing of scanning with the digital signature/time stamp shown in FIG. 3, firstly, for the purpose of judging, before execution of scanning, whether the multi-functional peripheral 1 (document reading portion 11) has the reading performance capable of adding the digital signature or the time stamp at the predetermined reading condition standard values, values indicative of the reading performance (maximum performance values) are obtained from the storage device 19 of the multi-functional peripheral itself, etc. Based on the maximum performance values, the reading performance value table shown in FIG. 5 is prepared and is stored in the storage device 19 or the external storage medium 20.

The reading performance determining portion 15c extracts the lowest value in all kinds of documents in each item (such as resolution, color, gradation, and document size) of the reading conditions (minimum values) of the reading condition table shown in FIG. 4 and compares such value with the value shown for corresponding item of the reading performance value table shown in FIG. 5. Namely, if the scanner does not have the performance required for adding the digital signature or the time stamp with respect to any kind of document, the scanning operation itself becomes invalid and therefore, the information to demand suspension of the processing is returned by the reading performance determining portion 15c to the digital signature adding control portion 15a.

In FIG. 5, the reading performance value table stored in the storage device 19 or the external storage medium 20 is registered with the maximum performance value (for example, resolution: 600 dpi, color/monochrome: color, gradation: 256, scanned document size: A3, etc.) of each reading performance item of the document reading portion 11. At the time of reading the original document at the document reading portion 11, the reading performance determining portion 15c executes the processing of determining whether the maximum performance value of each reading performance item matches the reading condition (minimum value) of the reading condition table shown in FIG. 4.

The digital signature adding control portion 15a does not execute the digital signature processing to the original document if the maximum value of each reading performance item does not match any of the predetermined reading condition standard values, as a result of the determination by the reading performance determining portion 15c. For example, the reading processing may be suspended before the document reading portion 11 reads the original document.

As seen above, since the multi-functional peripheral can determine whether the peripheral has the performance of the reading conditions complying with the guidelines of ministries, for example, if the multi-functional peripheral having the performance satisfying such reading conditions is detected on the network, the user can save time for searching for the multi-functional peripheral capable of adding the digital signature or the time stamp. When the multi-functional peripheral does not satisfy the reading conditions for adding the digital signature or the time stamp, the user is prevented from continuing to execute subsequent operation and the user can be saved from doing useless work.

In the above, if the reading performance of the document reading portion 11 satisfies the predetermined reading conditions, then the processing of setting reading condition values of the document reading portion 11 by the kind of original document is executed based on the input by the user or automatic setting. Description will now be made of the example of setting the reading condition values by the user's input, based on the operational screens shown in FIGS. 6 and 7.

FIG. 6 depicts an example of an operation screen at the time of selecting and fixing inputting the kind of document to be digitized. The operation screen is displayed for selecting and fixing the kind of document (purchase order, receipt, application drawing, etc.) at the time of executing the processing of scanning with the digital signature/time stamp. This operation screen is displayed at the operation/display portion 14 by the reading condition value setting portion 15d, and the kind of original document is selected according to the user's input. Thus selected kind of original document is fixed by depressing a “fix” button.

FIG. 7 depicts an example of an operation screen at the time of inputting to set the reading condition values. When the “fix” button shown in FIG. 6 is depressed and, for example, “purchase order” is selected, the reading conditions (minimum values) according to such original document are displayed so as to be changeable by the user. Here, it may be so arranged by the reading condition value setting portion 15d that values less than the minimum values of the reading condition standard values in the reading condition table shown in FIG. 4 can not be set. For example, in the case of the purchase order in the reading condition table, since the minimum value of the resolution is “200”, it is so arranged that even if the user attempts to select a value less than “200”, such attempt will not be accepted.

As seen above, the reading conditions for actually scanning are controlled so as not be set at the value less than the minimum value of each item of the reading condition table with respect to the kind of document specified by the user. This enables compliance with the laws, regulations and rules such as the guidelines of the e-Document Law.

It may be so arranged that the kind of original document can automatically be determined and that the reading condition value setting portion 15d sets the reading condition values by the kind of original document in accordance with the determined kind of original document at the time of reading the original document by the document reading portion 11. The processing of determining the kind of original document can be realized, for example, by applying a method of detecting the document kind ID included in the original document or a method of determining based on a layout, etc., of the original document. According to the kind of original document thus determined, the reading condition values are set. The reading condition values at this moment are, for example, correlated in advance with the minimum value, the maximum value, or user-wanted value of each item in the reading conditions depending on the kind of document.

As seen above, it may be so arranged that the reading condition values are set in accordance with the kind of document automatically determined rather than the reading condition values are set by the user's input. Even in this case, it may be so arranged that setting can not be made at the value less than the minimum values in the reading condition standard values in the reading condition table in FIG. 4.

The e-Document Law specifies the prohibited setting items depending on the kind of scanned image. Accordingly, it may be so arranged that, as shown in FIG. 4, the prohibited setting items (for example, image correction, Nin1 (collective printing), color adjustment, enlargement/reduction, etc.) are specified, by the kind of original document, in the reading condition table. The reading condition value setting portion 15d, at the time of setting the reading condition values by the kind of original document, refers to the reading condition table, and if the prohibited setting item is specified for the kind of original document, causes the specified prohibited setting item not to be set for example, by graying out so that the user can not select such setting item. FIG. 8 shows the state of the prohibited setting items being grayed out.

As seen above, by linking the reading conditions with the operation of the multi-functional peripheral, the user can perform a digitizing work without being conscious about the reading conditions specified by the laws, regulations and rules and even the user not accustomed to the operation can easily set the reading condition values.

Since the values of minimum reading conditions specified for respective kinds of document are set and displayed at first, the confirming operation alone can satisfy the specified reading conditions, contributing to improvement of work efficiency.

Since it is so configured that the reading condition values can be changed depending on the kind of document, it is not necessary to be extra conscious about the reading conditions for each ministry or agency that stipulates the laws, regulations and rules. Namely, digitized documents can be prepared in compliance with the reading conditions of each ministry or agency, without the necessity of being conscious about the reading conditions of many ministries.

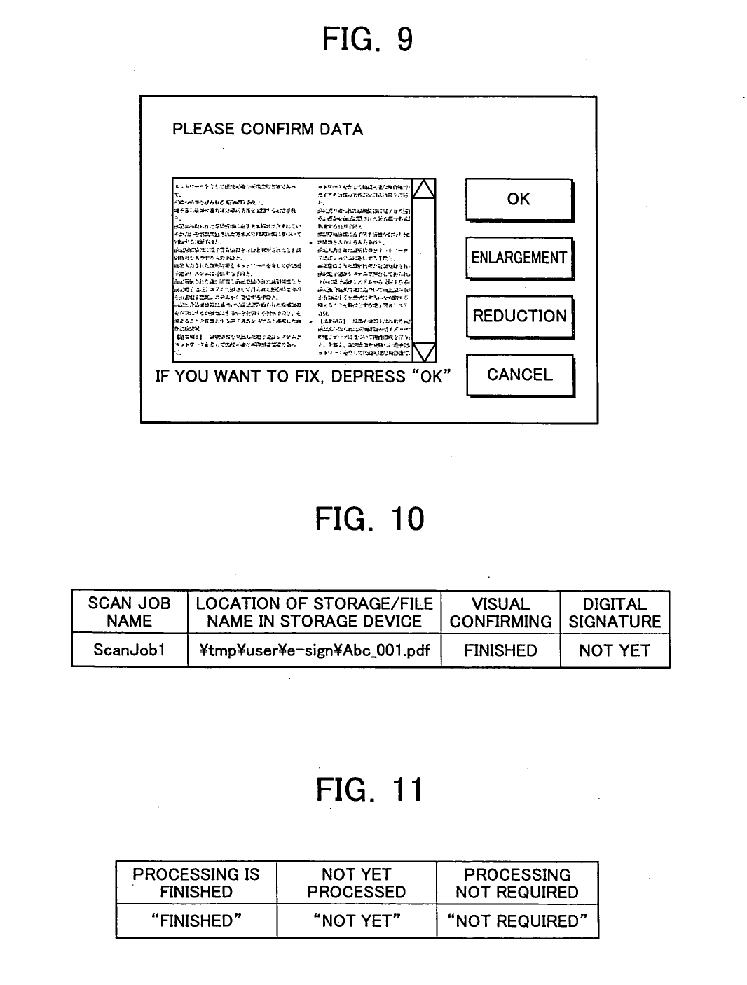

In the e-Document Law, the visual confirming condition is specified depending on the kind of the scanned image. Accordingly, it may be so arranged that the visual confirming condition can be specified, by the kind of original document, in the reading condition table, as shown in FIG. 4. The reading condition value setting portion 15d, at the time of setting the reading condition values by the kind of document, refers to the reading condition table and, if the visual confirming condition is specified for the kind of original document (in the case of “required” of the visual confirming condition in FIG. 4), causes the image data read at the document reading portion 11 to be displayed at the operation/display portion 14 as shown in FIG. 9, before adding the digital signature. This enables visual confirming by the user.

FIG. 10 depicts an example of an image visual confirming table. This image visual confirming table is stored in the storage device 19 or the external storage medium 20 and has registered a scanned job name, a location of storage or a file name of the image data before adding the digital signature/time stamp, etc., and further has registered the information indicating whether each processing of the visual confirming or digital signature is completed.

FIG. 11 depicts kinds of parameters, and meanings thereof, to be registered for the visual confirming and the digital signature that are processing items within the image visual confirming table shown in FIG. 10. In each processing item within the image visual confirming table, distinction is made among “finished” to indicate that the processing is completed, “not yet” to indicate that the processing is not yet executed, and “not required” to indicate that the processing itself is not required.

When the visual confirming condition is specified for the kind of document selected by the user in the reading condition table shown in FIG. 4, the scanned image data is displayed on the operation/display portion 14 as shown in FIG. 9. If there is no problem with the actually scanned image data, the user depresses an “OK” button in FIG. 9 and fixes adoption of the image data. When the adoption of the image data is fixed, the information indicating completion of the processing (“finished” in the present example) is registered under the “visual confirming” in the image visual confirming table shown in FIG. 10.

When the visual confirming has been executed at the operation/display portion 14, the digital signature adding control portion 15a adds the digital signature to the image data read at the document reading portion 11, based on the information indicating that the visual confirming has been executed, namely, when the “finished” is registered under the “visual confirming” in the image visual confirming table.

The guidelines of the e-Document Law expressly state that the visual confirming shall be executed before storing the scanned image data. This reflects the consideration that since the scanned image data can be an original, the scanned image data will not become the script that can not be confirmed later due to an error in setting the document for scanning, etc. In this respect, in the multi-functional peripheral of the present invention, when the visual confirming is included in the reading conditions of guidelines, etc., the visual confirming condition can be added to the reading condition table. When the visual confirming condition is included, the multi-functional peripheral automatically displays the scanned image data on its operation/display portion so that the user can perform the visual confirming. This can prevent a simple error such as a failure to perform the visual confirming.

When in the laws, regulations, rules, etc., the visual confirming is included in the reading conditions, the information indicating that the user has completed the visual confirming is memorized and it is so designed that if the user does not perform the visual confirming, the processing of adding the digital signature/time stamp can not be executed. Therefore, such errors as adding the digital signature to inappropriate scanned image data can be prevented at the stage of visual confirming, and simple errors can be reduced.

The e-Document Law specifies “being a color display of 14 inches or over”, “being capable of reading a character of 4 point or over”, etc., as conditions concerning apparatuses capable of reading the electronic document. For this reason, it may be so arranged that the multi-functional peripheral 1 determines whether the operation/display portion 14 satisfies the above conditions.

The multi-functional peripheral 1 is designed to be connectable with an external display apparatus having the screen of a predetermined size (14 inches in the present case) or over. For example, the external display apparatus, etc., of the information processing apparatus 3 is connected to the multi-functional peripheral 1. The control portion 15 controls the multi-functional peripheral 1 so that the image data read at the document reading portion 11 is outputted for display at the external display apparatus when it judges that the screen size of the operation/display portion 14 is smaller than 14 inches and the image data read at the document reading portion 11 is outputted for display at the operation/display portion 14 when it judges that the screen size of the operation/display portion 14 is equal to or larger than 14 inches. In this manner, even if the display portion provided in the multi-functional peripheral does not satisfy predetermined display conditions, the scanned image data can be displayed in compliance with the predetermined display conditions by utilizing the external display apparatus.

It may be so arranged that, as shown in FIG. 2, the multi-functional peripheral 1 is equipped with the OCR 15f that converts the image data read at the document reading portion 11 to character data and calculates the point number of the character data. In this case, the digital signature adding control portion 15a does not add the digital signature to the image data read at the document reading portion 11 when the point number of the character data calculated by the OCR portion 15f is smaller than a predetermined point number. For example, control is executed not to adopt the scanned image data. Or it may be so arranged that the operation/display portion 14 displays the information to give a notice to the effect that the point number of the character data calculated at the OCR portion 15f is smaller than the predetermined point number.

The e-Document Law specifies the time stamp condition in addition to the digital signature, depending on the kind of scanned image. Accordingly, it may be so arranged that, as shown in FIG. 4, the time stamp condition can be specified by the kind of original document in the reading condition table. The time stamp adding control portion 15b does not add the time stamp to the image data when the time stamp condition is specified in the reading condition table and the digital signature is not added to the image data read at the document reading portion 11. On the other hand, the time stamp adding control portion 15b executes the processing of adding the time stamp to the image data when the time stamp condition is specified in the reading condition table and the digital signature is added to the image data read at the document reading portion 11.

The multi-functional peripheral 1 includes, in the storage device 19 or the external storage medium 20, the image visual confirming table shown in FIG. 10 as a storage portion for storing the information indicating that the digital signature has been added to the image data read at the document reading portion 11. When the digital signature has been added to the image data, the “finished” is registered under the “digital signature” in the image visual confirming table. The time stamp adding control portion 15b, in the case of determining from the image visual confirming table that the digital signature has been added, executes the processing of further adding the time stamp to the corresponding image data with the digital signature already added thereto.

For example, in the e-Document Law, the guidelines of National Tax Administration Agency provide that, in the case of making the digitized data as an original, both the digital signature and the time stamp shall be added thereto. For this reason, in the case of adding the time stamp to the digitized image data, the digital signature is required to be added thereto in advance. Therefore, user's simple error can be reduced by so arranging that the processing of adding the time stamp can automatically be suspended when the processing of adding the digital signature has not been executed.

In the course of executing the processing of adding the digital signature and the time stamp, when a situation happens in which other processing of higher priority (e.g., fax reception, etc.) interrupts, forcing the multi-functional peripheral to suspend its processing and wait, the state of the processing at that moment may be memorized. Since such arrangement enables automatic control to continue at the time of restarting the processing, the user is not required to memorize the state of the processing and the occurrence of errors in work can be reduced.

FIG. 12 is a flow chart for description of a flow of overall processing of scanning with the digital signature/time stamp. In this example, detailed description will be made of the processing flow at step S5 shown in FIG. 3. Firstly, the multi-functional peripheral 1 executes the processing of judging whether the reading performance values (such as resolution) of the document reading portion 11 match the predetermined reading condition standard values, namely “scanner performance judging processing” (step S11). The multi-functional peripheral 1 judges whether the document reading portion 11 can execute the processing (step S12) and, if the processing can be executed (step S12: Yes), displays the operation screen shown in FIG. 6, namely, the screen for selecting and fixing inputting of the kind of document to be digitized, at the operation/display portion 14 of the multi-functional peripheral 1 (step S13). The user selects the kind of document on this selecting and fixing inputting screen and depresses the “fix” button. At step S12, if the processing of adding the digital signature/time stamp can not be executed due to the reason such as the processing performance of the document reading portion 11 being less than the scanner reading conditions (step S12: No), then an error is displayed and the processing is finished (step S14).

Next, when the kind of document to be digitized is fixed at step S13, the multi-functional peripheral 1 executes the processing of fixing the reading condition values greater than the reading conditions depending on the kind of document and judging whether the fixed values match the predetermined reading condition standard values, namely, “reading conditions match judging processing” (step S15). In this processing, for example, the reading condition values are input and fixed on the operation screen shown in FIG. 7 and judgment is made of whether such values match the reading condition standard values. Then, the multi-functional peripheral 1 displays a screen for inputting the destination at which to store the scanned image data with the digital signature or the time stamp added and the name of the file to be sent, and the user inputs and fixes such data (step S16).

The processing heretofore has fixed the reading condition values, the destination, and the file name. Next, actual scanning processing is executed. The user sets a paper document and depresses a scan executing button to execute the scanning (step S17).

Next, to confirm whether the image data scanned and digitized is correctly scanned, before the addition of the digital signature or the time stamp, the multi-functional peripheral 1 displays the image data at the operation/display portion 14 as shown in FIG. 9 and executes the visual confirming processing by the user, namely, “read image visual confirming processing” (step S18).

The multi-functional peripheral 1 judges, at instruction by the user, whether to adopt the visually confirmed image data (step S19). If the image data is not adopted including, for example, the case where the image data was not correctly scanned (step S19: No), then the image data is discarded and the processing is suspended and finished. On the other hand, if the image data is adopted (step S19: Yes), then “digital signature processing” is executed depending on the kind of image data (step S20).

Then, the multi-functional peripheral 1 judges whether the time stamp processing is further required for the image data with the digital signature already added thereto (step S21) and, if the time stamp processing is required (step S21: Yes), applies “time stamp processing” to the image data with the digital signature (step S22) and sends the image data with the digital signature and the time stamp to the destination set at step S16 (step S23). On the other hand, at step S21, if the time stamp processing is not required (step S21: No), then the multi-functional peripheral 1 sends the image data with the digital signature to the destination set at step S16 (step S24).

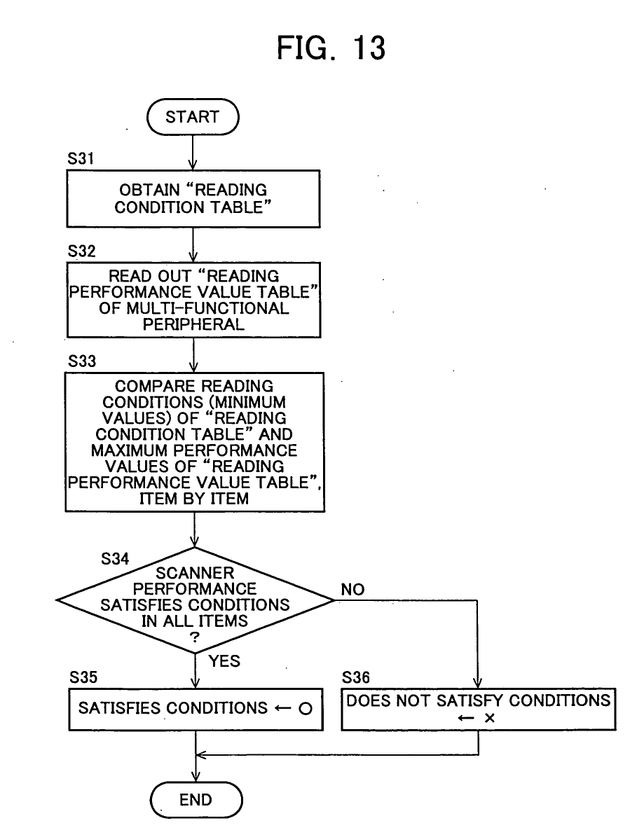

FIG. 13 is a flow chart for detailed description of the scanner performance judging processing at step S11 of FIG. 12. Firstly, the multi-functional peripheral 1 obtains the reading condition table from the storage device 19 or the information processing apparatus 3, etc., on the network 2 (step S31). This reading condition table is the one shown in FIG. 4 and is the table in which the scanner reading conditions, etc., are prepared and registered in advance by an administrator, etc., in compliance with the laws, regulations and rules such as the e-Document Law. The table is configured so that the registered conditions are classified by the kind of document and a value can be set at each item including the reading conditions depending on the kind of document.

Next, the multi-functional peripheral 1 reads out the reading performance value table thereof so that the multi-functional peripheral 1 can judge, before execution of scanning, whether the multi-functional peripheral 1 has the reading performance capable of adding the digital signature or the time stamp (step S32). This reading performance value table is the one shown in FIG. 5, is prepared based on the values indicative of the reading performance obtained from the storage device 19, etc., of the multi-functional peripheral 1 itself, and is stored in advance in the storage device 19 or the external storage medium 20.

Next, the multi-functional peripheral 1 extracts the lowest value out of the minimum values of each item (resolution, color, gradation, etc.) registered as the reading conditions by the kind of document in the reading condition table and compares such value with the value (maximum performance value) of the corresponding item of the reading performance table (step S33). Then, the multi-functional peripheral 1 judges whether the scanner performance satisfies the reading conditions in all items (step S34) and, if the scanner performance satisfies the reading conditions (step S34: Yes), returns the information indicating that the scanner performance satisfies the conditions (step S35). On the other hand, at step S34, if the scanner does not have the performance of adding the digital signature or the time stamp for any kind of document (step S34: No), then the scanning operation itself becomes invalid and therefore, the multi-functional peripheral 1 returns the information indicating that the scanner performance does not satisfies the conditions and causes the processing to be suspended (step S36).

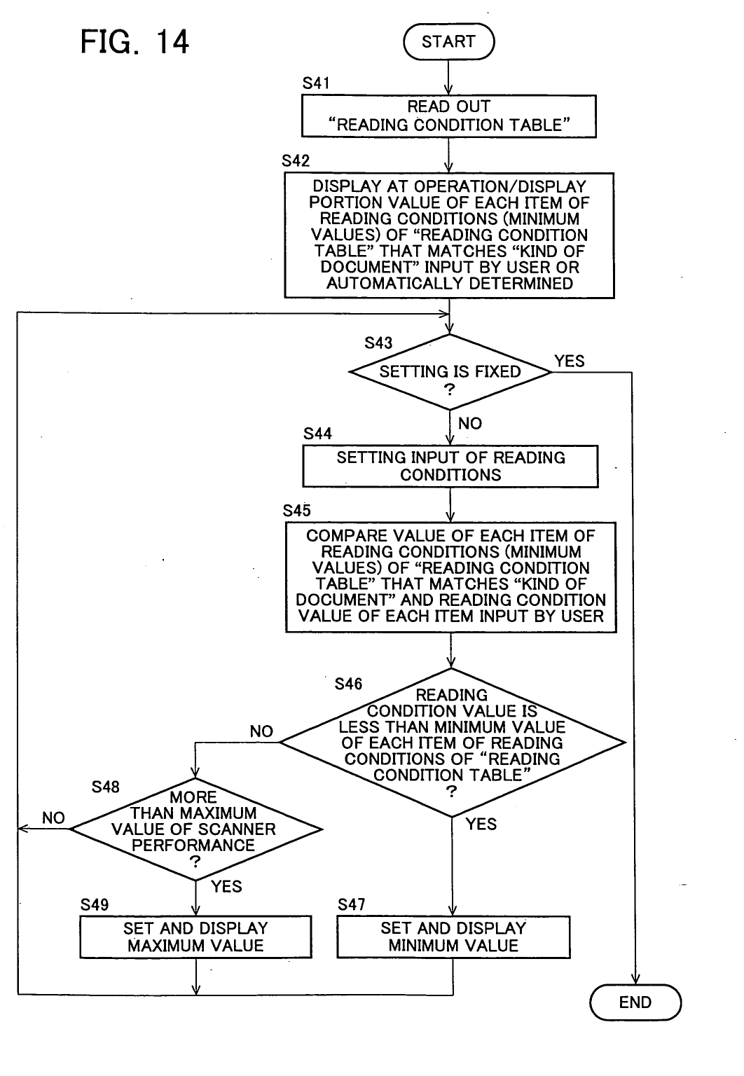

FIG. 14 is a flow chart for detailed description of the reading condition match judging processing at step S15 of FIG. 12. Firstly, the multi-functional peripheral 1 reads out the reading condition table obtained in the scanner performance judging processing (step S41), displays, at the operation/display portion 14, such value of each item of the reading conditions (minimum value) in the reading condition table that matches the “kind of document” input by the user or automatically determined (step S42). The screen at this moment is the one shown in FIG. 7 and the value of each item is displayed so as to be changeable by the user.

However, control is executed so that the value can not be set even if the user attempts to change the value to the value less than the minimum value of the reading condition table. For example, in the case of selection by the user of the “purchase order” as the kind of document, since the minimum value of the resolution for the “purchase order” in the reading condition table of FIG. 4 is “200”, the multi-functional peripheral 1 is designed not to accept the value less than “200” even if the user attempts to set such value.

Next, the multi-functional peripheral 1 judges whether the input setting is fixed with respect to the reading conditions displayed at the operation/display portion 14 (step S43). If the input setting is fixed (step S43: Yes), then the processing is finished. On the other hand, at step S43, if the input setting is not fixed (step S43: No), then the multi-functional peripheral 1 accepts the input setting of the reading condition values on the screen (screen shown in FIG. 7) displayed at the operation/display portion 14 (step S44).

The multi-functional peripheral 1 compares such value (reading condition standard value) of each item of the reading conditions (minimum values) of the reading condition table that matches the “kind of document” with the reading condition value of each item input by the user on the screen shown in FIG. 7 (step S45) and then judges whether the reading condition values input by the user are less than the minimum values of the items of the reading conditions in the reading condition table (step S46).

At step S46, if the reading condition values input by the user are less than the minimum values of the items of the reading conditions it the reading condition table (step S46: Yes), then the multi-functional peripheral 1 sets and display the minimum values (step S47) and the flow goes back to step S43 for repeating of the processing. On the other hand, at step S46, if the reading condition values input by the user are not less than the minimum values (step S46: No), then the multi-functional peripheral 1 judges whether the reading condition values input by the user are more than the maximum values of the scanner performance (step S48). If the reading condition values input by the user are more than the maximum values of the scanner performance (step S48: Yes), then the multi-functional peripheral 1 sets and display the maximum values (step S49) and the flow goes back to step S43 for repeating of the processing. On the other hand, at step S48, if the reading condition values input by the user are not more than the maximum values of the scanner performance (step S48: No), then the flow goes back to step S43 for repeating of the processing.

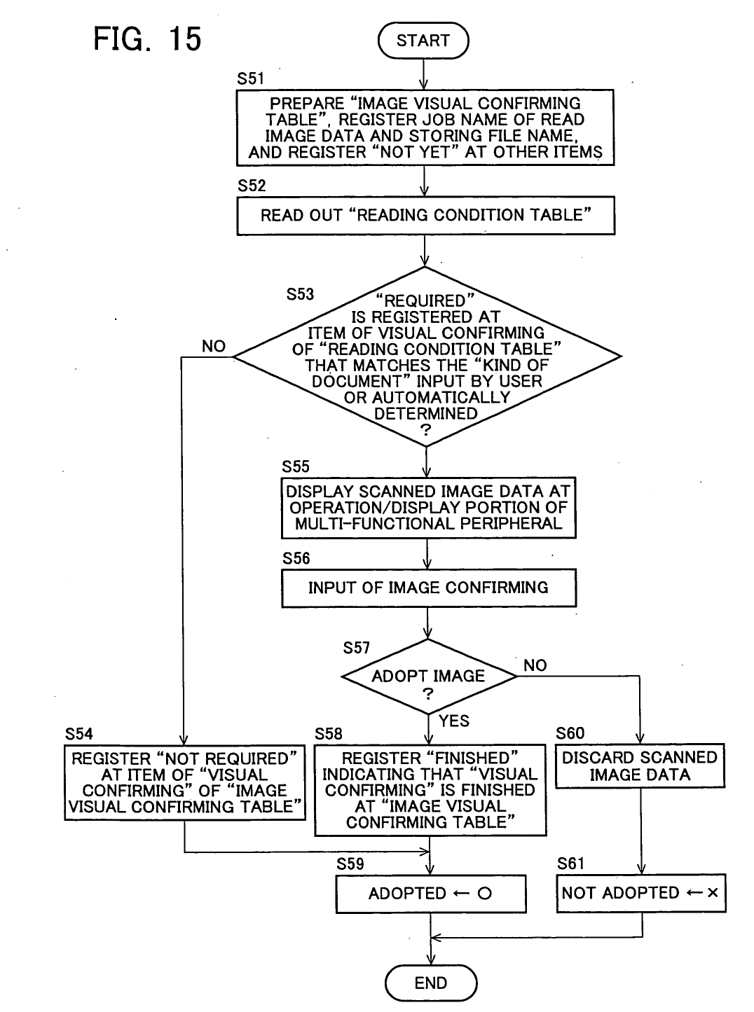

FIG. 15 is a flow chart for detailed description of the read image visual confirming processing at step S18 of FIG. 12. Firstly, the multi-functional peripheral 1 prepares the image visual confirming table shown in FIG. 10 and registers a job name of the read image data and a storing file name and registers the information indicating that the processing is not yet complete for other items (in the example of FIG. 10, “visual confirming” and “digital signature”) (step S51).

Next, the multi-functional peripheral 1 reads out the reading condition table obtained at the “scanner performance judging processing” shown in FIG. 13 (step S52) and judges whether the information that the visual confirming is required is registered at the item of the visual confirming in the reading condition table matching the “kind of document” input by the user or automatically determined (step S53). If the visual confirming is not required (the case “not required” is registered in FIG. 4), then the multi-functional peripheral 1 registers “not required” at the item of “visual confirming” in the image visual confirming table shown in FIG. 10 (step S54), without executing the processing of displaying or confirming the scanned image data, and returns the information indicating that the image is adopted and completes the processing (step S59).

On the other hand, at step S53, if the visual confirming is required (the case “required” is registered in FIG. 4), then the multi-functional peripheral 1 displays the scanned image data at the operation/display portion 14 as shown in FIG. 9 (step S55) and accepts the input of the image confirming at the operation/display portion 14 (step S56).

The multi-functional peripheral 1 judges, according to the input by the user, whether to adopt the scanned image data (step S57). When the image data is adopted, namely, when the scanned image data has no problem and the user has fixed the adoption of the scanned image data by depressing the “OK” button (step S57: Yes), the multi-functional peripheral 1 registers the information that the processing is complete (“finished” in the case of FIG. 10) at the item of the visual confirming of the image visual confirming table (step S58), moves the flow to step S59, returns the information indicating that the image is adopted and finishes the processing.

On the other hand, at step S57, when the image data is not adopted, namely, when the scanned image data has a problem (such as back side of document, light color, inclined image) and the user has fixed non-adoption of the scanned image data by depressing “cancel” button (step S57: No), the multi-functional peripheral 1 discards the scanned image data (step S60), moves the flow to the step S61, returns the information of non-adoption, and completes the processing.

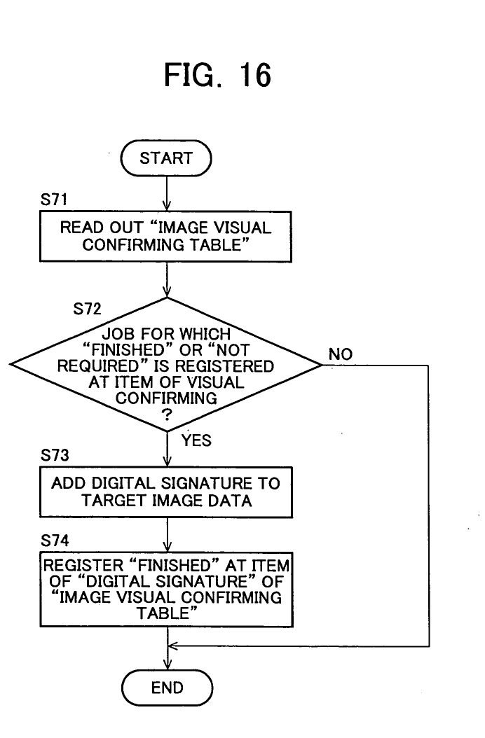

FIG. 16 is a flow chart for detailed description of the digital signature processing at step S20 of FIG. 12. After the adoption of the scanned image data is fixed, the multi-functional peripheral 1 executes the processing of adding the digital signature to the read image data. Firstly, the multi-functional peripheral 1 reads out the image visual confirming table stored in the storage device 19 or the external storage medium 20 (step S71) and judges whether the scan job is the job for which “finished” or “not required” is registered at the item of the visual confirming in the read out image visual confirming table (step S72).

At step S72, when the “finished” that is the information indicating that the visual confirming is complete or the “not required” that is the information indicating that the visual confirming is not required is registered at the item of the visual confirming in the image visual confirming table, the multi-functional peripheral 1 continues the processing, adds the digital signature to the target data that matches the scan job name and the location of storage and file name within the storage device in the image visual confirming table (step S73), and registers the “finished” at the item of “digital signature” in the image visual confirming table (step S74). On the other hand, at step S72, when the “not yet” that is other information is registered (step S72: No), the multi-functional peripheral 1 finishes the processing without executing the processing of adding the digital signature.

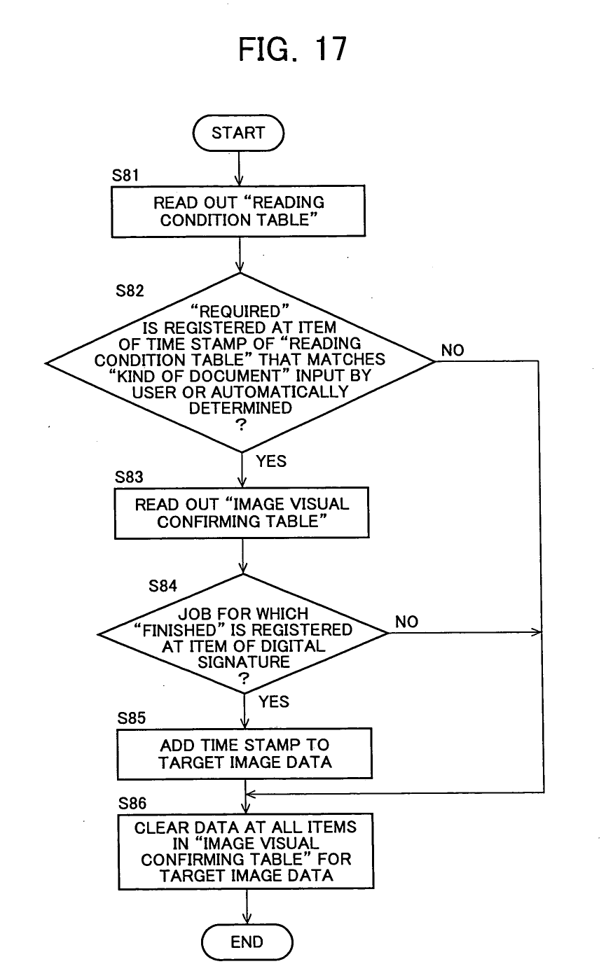

FIG. 17 is a flow chart for detailed description of the time stamp processing at step S22 of FIG. 12. Firstly, the multi-functional peripheral 1 reads out the reading condition table obtained at the “scanner performance judging processing” shown in FIG. 13 (step S81) and judges whether the information that the time stamp is required is registered at the item of the time stamp of the reading condition table that matches the “kind of document” input by the user or automatically determined (step S82). If the information that the time stamp is required (“required” in the case of FIG. 4) is registered (step S82: Yes), then the multi-functional peripheral 1 reads out the image visual confirming table indicating the present status (step S83).

The multi-functional peripheral 1 judges whether the job is the job for which the information indicating that the digital signature processing is complete or not required (“finished” in the example of FIG. 10) is registered at the item of the digital signature in the image visual confirming table (step S84). If the “finished” is registered at the “digital signature” in the image visual confirming table (step S84: Yes), then the multi-functional peripheral 1 adds the time stamp to the target data that matches the scan job name and the location of storage and file name within the storage device in the image visual confirming table (step S85), clears data at all items of the image visual confirming table, and finishes the processing (step S86).

If, at step S82, the information that the time stamp is not required is registered at the item of the time stamp in the reading condition table (step S82: No) or if, at step S84, the information that the digital signature adding processing is not yet complete (“not yet” in the example of FIG. 10) at the item of the digital signature in the image visual confirming table (step S84: No), then the multi-functional peripheral 1 moves the flow to step S86 without executing the time stamp adding processing, clears data at all items of the image visual confirming table, and finishes the processing.

### Second Embodiment

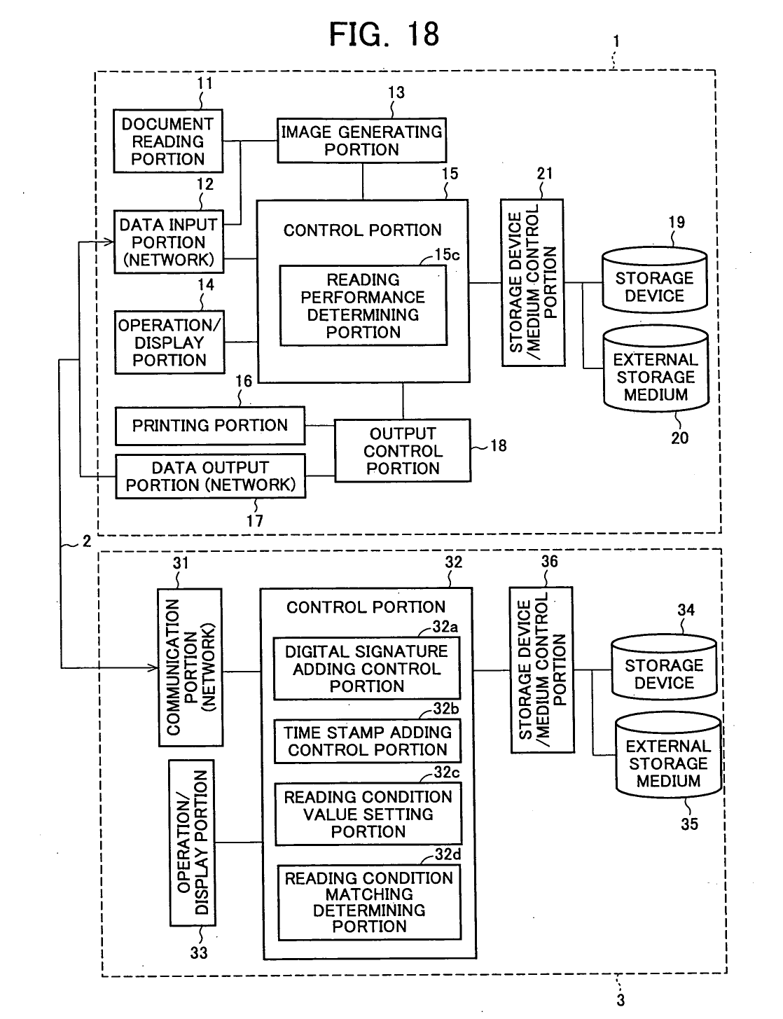

FIG. 18 depicts a configuration example of an image processing system according to another embodiment of the present invention. In FIG. 18, the information processing apparatus 3 can connect with one or more multi-functional peripheral(s) by way of the network 2 and is capable of mutual communication of receiving or transmitting data from or to the multi-functional peripheral 1. In the present embodiment, the multi-functional peripheral 1 is equipped with the reading performance determining portion 15c and the information processing apparatus 3 is equipped with the digital signature adding control portion 32a, the time stamp adding control portion 32b, the reading condition value setting portion 32c, and the reading condition matching determining portion 32d.

The information processing apparatus 3 comprises the communication portion 31 for input and output of data from or to the multi-functional peripheral 1 by way of the network 2, the control portion 32 that controls the operation of the information processing apparatus 3, the operation/display portion 33 for display of various kinds of information or giving operational instructions to the information processing apparatus 3, the storage device 34 such as a hard disk and a semiconductor memory, the external storage medium 35 such as a USB memory and a memory card, and the storage device/medium control portion 36 that controls the operation of the storage device 34 and the external storage medium 35.

The information processing apparatus 3 is equipped with the control portion 32 composed of a CPU that performs arithmetic operation and a RAM, etc., that store temporary information in the arithmetic operation. The control portion 32 includes a ROM that stores a control program for controlling the information processing apparatus 3. This ROM stores portions for executing the functions of the information processing apparatus of the present invention, namely, a digital signature adding control portion 32a, a time stamp adding control portion 32b, a reading condition value setting portion 32c, and a reading condition matching determining portion 32d, all in the form of programs, which are read out by the CPU to the RAM for processing at the time of execution.

In the processing flow shown in FIG. 12, the multi-functional peripheral 1 is designed to execute the “scanner performance judging processing” at step S11 and the information processing apparatus 3 is designed to execute the subsequent processing, namely, the “reading condition match judging processing” at step S15, the “read image visual confirming processing” at step S18, the “digital signature processing” at step S20, and the “time stamp processing” at step S22. It may be so arranged that table data such as the reading condition table shown in FIG. 4, the reading performance value table shown in FIG. 5, and the image visual confirming table shown in FIG. 10 are stored in the storage device, etc. of either one or both of the multi-functional peripheral 1 and the information processing apparatus 3.

### Third Embodiment

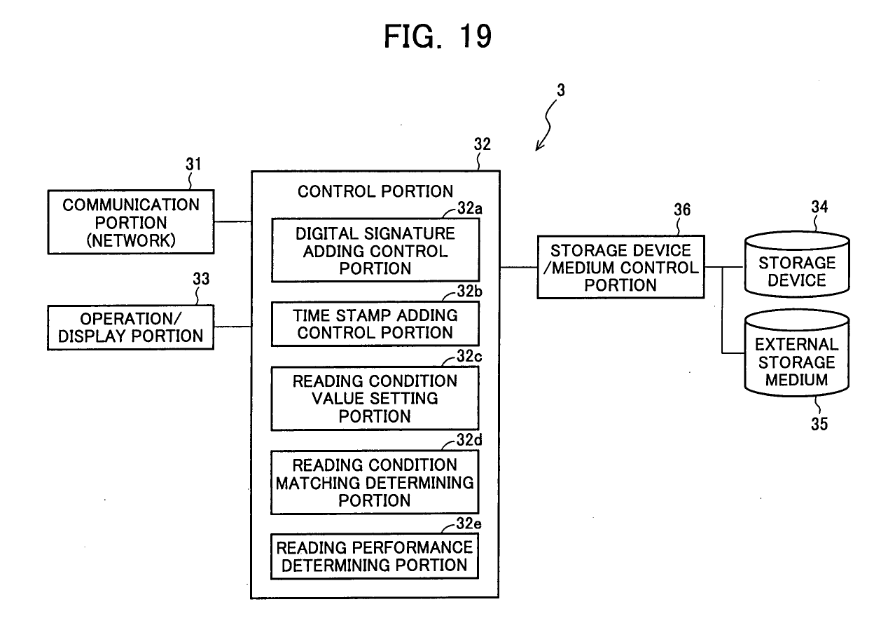

FIG. 19 depicts a configuration example of the information processing apparatus according to other embodiment of the present invention. In FIG. 19, the information processing apparatus 3 can connect with one or more multi-functional peripheral(s) by way of the network 2 and is capable of mutual communication of receiving or transmitting data from or to the multi-functional peripheral 1. In the present embodiment, the information processing apparatus 3 is equipped with the digital signature adding control portion 32a, the time stamp adding control portion 32b, the reading condition value setting portion 32c, the reading condition matching determining portion 32d, and the reading performance determining portion 32e.

In the processing flow shown in FIG. 12, the information processing apparatus 3 is designed to execute the “scanner performance judging processing” at step S11, the “reading condition match judging processing” at step S15, the “read image visual confirming processing” at step S18, the “digital signature processing” at step S20, and the “time stamp processing” at step S22. It may be so arranged that table data such as the reading condition table shown in FIG. 4, the reading performance value table shown in FIG. 5, and the image visual confirming table shown in FIG. 10 are stored in the storage device, etc. of either one or both of the multi-functional peripheral 1 and the information processing apparatus 3.

While description has been made of each embodiment mainly about functions in the image processing apparatus, the system and the information processing apparatus of the present invention, the present invention can also assume the form of image processing method, as described as a method of executing each step in the image processing apparatus. The present invention can also assume the form of program that causes a computer to function as the image processing apparatus, the system and the information processing apparatus in the same way as the apparatuses and the system having such functions and the form of recording medium recorded with the program.

Description will be made of the embodiment of a recording medium that records the program or data for realizing each function of the present invention. Conceivable recording medium is, specifically, a CD-ROM (-R/-RW), an optical disk, a DVD-ROM (-R/-RW/-RAM), an FD, an HD, a BD, a flash memory, a memory card, a memory stick, and various kinds of ROMs and RAMs, and by recording on these recording media, and circulating, the program for causing the computer to execute the functions as the apparatus and the system of each embodiment of the present invention described above and for realizing each function of the present invention, the realization of such functions will be facilitated. By loading the recording medium described above to the information processing apparatus such as the computer and having the program read out by the information processing apparatus or by storing the program in the storage medium provided in the information processing apparatus and having the program read out as required, each function according to the present invention can be executed.

As described above, since the present invention enables comparing the predetermined reading condition standard values complying with the guidelines, etc, of the e-Document Law with the reading condition values set at the apparatus itself and executing the processing of adding the digital signature, the time stamp, etc., to the image data read from the original document only when the reading condition values match the predetermined reading condition standard values, human errors can be reduced such as an error in the operation of setting the reading condition values by the user.

1. An image processing apparatus comprising:
a reading portion that optically reads an original document and inputs image data; and
a digital signature adding portion that adds a digital signature to the read image data, wherein
the image processing apparatus comprises:
a reading condition value setting portion that sets, at the time of reading of original document by the reading portion, reading condition values by a kind or an address for submission of the original document; and
a reading condition matching determining portion that determines whether the set reading condition values match predetermined reading condition standard values, wherein
the digital signature adding portion does not add a digital signature to the image data read at the reading portion when, as a result of determination by the reading condition matching determining portion, the reading condition values do not match the predetermined reading condition standard values.

2. The image processing apparatus of claim 1, comprising:
a storage portion that stores predetermined reading condition standard values by a kind or an address for submission of original document; and
a control portion that controls processing of rewriting the predetermined reading condition standard values, wherein
the predetermined reading condition standard values can be rewritten before reading of original document by the reading portion.

3. The image processing apparatus of claim 2, comprising:
a connecting portion that connects with an external storage device that stores predetermined reading condition standard values by a kind or an address for submission of original document, wherein
the predetermined reading condition standard values stored in the external storage device can be read before reading of original document by the reading portion.

4. The image processing apparatus of claim 1, wherein
the reading condition value setting portion can not set a value less than a minimum value out of the predetermined reading condition standard values at the time of setting reading condition values by a kind or an address for submission of original document.

5. The image processing apparatus of claim 1, wherein
the reading condition value setting portion can set, at the time of reading of original document by the reading portion, reading condition values by a kind or an address for submission of the original document in accordance with input by a user.

6. The image processing apparatus of claim 1, wherein
the reading condition value setting portion can determine a kind or an address for submission of original document and can set, at the time of reading of original document by the reading portion, reading condition values by a kind or an address for submission of the original document, in accordance with the determined kind or address for submission of the original document.

7. The image processing apparatus of claim 1, comprising a reading condition table in which prohibited setting items can be specified by a kind or an address for submission of original document, wherein
the reading condition value setting portion, at the time of setting reading condition values by a kind or an address for submission of original document, refers to the reading condition table and, when prohibited setting items are specified for the kind or the address for submission of the original document, can not set the specified prohibited setting items.

8. The image processing apparatus of claim 1, comprising:
a reading condition table in which visual confirming condition can be specified by a kind or an address for submission of original document; and
a display portion that displays various kinds of information, wherein
the reading condition value setting portion, at the time of setting reading condition values by a kind or an address for submission of original document, refers to the reading condition table and, when the visual confirming condition is specified for the kind or the address for submission of the original document, displays, at the display portion, the image data read by the reading portion, before adding a digital signature.

9. The image processing apparatus of claim 8, wherein
the digital signature adding portion, when the visual confirming by the display portion has been executed, adds a digital signature to the image data read at the reading portion, based on information indicating that the visual confirming has been executed.

10. The image processing apparatus of claim 8 connectable with an external display apparatus having a screen of a size equal to or larger than a predetermined size, wherein
when the screen size of the display portion is smaller than the predetermined size, the image data read at the reading portion is output for display at the external display apparatus.

11. The image processing apparatus of claim 8, comprising an OCR portion that converts the image data read at the reading portion to character data and calculates a point number of the character data, wherein
when the point number of the character data calculated by the OCR portion is smaller than predetermined point number, the digital signature adding portion does not add a digital signature to the image data read at the reading portion.

12. The image processing apparatus of claim 11, wherein
when the point number of the character data calculated by the OCR portion is smaller than predetermined point number, the display portion displays information giving notice to that effect.

13. The image processing apparatus of claim 1, comprising:
a storage portion that stores a maximum value of each reading performance item of the reading portion; and
a reading performance determining portion that determines whether the maximum value of each reading performance item matches the predetermined reading condition standard values at the time of reading of original document by the reading portion, wherein
when, as a result of the determination by the reading performance determining portion, the maximum value of each reading performance item does not match any of the predetermined reading condition standard values, the digital signature adding portion does not execute digital signature processing to the original document.

14. The image processing apparatus of claim 13, wherein
when, as a result of determination by the reading performance determining portion, the maximum value of each reading performance item does not match any of the predetermined reading condition standard values, the digital signature adding portion suspends reading processing before the original document is read by the reading portion.

15. The image processing apparatus of claim 1, comprising:
a time stamp adding portion that adds a time stamp to image data; and
a reading condition table in which a time stamp condition can be specified by a kind or an address for submission of original document, wherein
when a time stamp condition is specified in the reading condition table and a digital signature is not added to the image data read at the reading portion, the time stamp adding portion does not add a time stamp to the image data.

16. The image processing apparatus of claim 15, comprising a storage portion that stores information indicating that the digital signature has been added to the image data read at the reading portion, wherein
when the information indicating that the digital signature has been added is stored, the time stamp adding portion further adds a time stamp to the image data with the digital signature added thereto.

17. An image processing system comprising:
an image processing apparatus that optically reads an original document and inputs image data; and
an information processing apparatus connected to the image processing apparatus, wherein
the information processing apparatus comprises:
a digital signature adding portion that adds a digital signature to image data;
a reading condition value setting portion that sets reading condition values by a kind or an address for submission of original document at the time of reading of original document by the reading portion; and
a reading condition matching determining portion that determines whether the set reading condition values match predetermined reading condition standard values, wherein
the digital signature adding portion does not add a digital signature to the image data read at the reading portion when, as a result of determination by the reading condition matching determining portion, the reading condition values do not match the predetermined reading condition standard values.

18. The image processing system of claim 17, wherein the image processing apparatus comprises:
a storage portion that stores a maximum value of each reading performance item of the image processing apparatus; and
a reading performance determining portion that determines whether the maximum value of each reading performance item matches the predetermined reading condition standard values at the time of reading of original document by the image processing apparatus, wherein
when, as a result of determination by the reading performance determining portion, the maximum value of each reading performance item does not match any of the predetermined reading condition standard values, the information processing apparatus does not execute digital signature processing to the original document.

19. The image processing system of claim 17 or 18, wherein
the image processing apparatus comprises:
a time stamp adding portion that adds a time stamp to image data; and
a reading condition table in which a time stamp condition can be specified by a kind or an address for submission of original document, wherein
when a time stamp condition is specified in the reading condition table and a digital signature is not added to the image data read at the image processing apparatus, the time stamp adding portion does not add a time stamp to the image data.

20. An information processing apparatus connectable to an image processing apparatus that optically reads an original document and inputs image data, comprising:
a digital signature adding portion that adds a digital signature to image data;
a reading condition value setting portion that sets reading condition values by a kind or an address for submission of original document at the time of reading of original document by the image processing apparatus; and
a reading condition matching determining portion that determines whether the set reading condition values match predetermined reading condition standard values, wherein
the digital signature adding portion does not add a digital signature to the image data read at the image processing apparatus when, as a result of determination by the reading condition matching determining portion, the reading condition values do not match the predetermined reading condition standard values.

21. The information processing apparatus of claim 20, comprising:
a storage portion that stores a maximum value of each reading performance item of the image processing apparatus; and
a reading performance determining portion that determines whether the maximum value of each reading performance item matches the predetermined reading condition standard values at the time of reading of original document by the image processing apparatus, wherein
when, as a result of determination by the reading performance determining portion, the maximum value of each reading performance item does not match any of the predetermined reading condition standard values, the digital signature adding portion does not execute digital signature processing to the original document.

22. The information processing apparatus of claim 20, comprising:
a time stamp adding portion that adds a time stamp to image data; and
a reading condition table in which a time stamp condition can be specified by a kind or an address for submission of original document, wherein
when the time stamp condition is specified in the reading condition table and a digital signature is not added to the image data read at the image processing apparatus, the time stamp adding portion does not add a time stamp to the image data.

23. An image processing method of an image processing apparatus having a reading portion that optically reads an original document and inputs image data, comprising:
a step of setting reading condition values by a kind or an address for submission of original document at the time of reading of original document by the reading portion;
a step of determining whether the set reading condition values match predetermined reading condition standard values; and
a step of controlling addition of a digital signature to the image data read at the reading portion based on a result of determination.

24. The image processing method of claim 23, comprising:
a step of determining whether a maximum value of each reading performance item of the reading portion matches the predetermined reading condition standard values at the time of reading of original document by the image processing apparatus; and
a step of controlling addition of a digital signature to the image data read at the reading portion based on a result of determination.

25. The image processing method of claim 23 or 24, comprising:
a step of controlling addition of a time stamp to the image data read at the reading portion based on a reading condition table in which a time stamp condition can be specified by a kind or an address for submission of original document; and
not adding a time stamp to the image data when a time stamp condition is specified in the reading condition table and a digital signature is not added to the image data read at the reading portion.

26. A program for executing a function as the image processing apparatus of any one of claims 1 to 16.

27. A program for executing a function as the information processing apparatus of any one of claims 20 to 22.
